(19) United States
(12) Patent Application Publication
(10) Pub. No.: US 2007/0195111 A1
(43) Pub. Date: Aug. 23, 2007

(54) DEVICE AND METHOD FOR OVERLAPPING MULTI-CHANNEL DIGITAL DISPLAY SIGNALS

(75) Inventors: Li YAO, Shenzhen (CN); Limai WAN, Shenzhen (CN)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SHENZHEN MINDRAY BIO-MEDICAL ELECTRONICS CO., LTD, Shenzhen (CN)

(21) Appl. No.: 11/565,457

(22) Filed: Nov. 30, 2006

(30) Foreign Application Priority Data
Feb. 23, 2006 (CN) 200610033914.3

(51) Int. Cl. G09G 5/00

(52) U.S. Cl. 345/634

(57) ABSTRACT

The present invention discloses a device for overlapping multi-channel digital display signals, the device comprises: a first display signal inputting channel; a second display signal inputting channel; a coordinate generating unit for generating coordinates of a second display window; a detection unit for receiving coordinates of pixel currently being scanned and the coordinates of the second display window, comparing therebetween, and outputting a valid level when the coordinates of the pixel currently being scanned fall within the scope of the coordinates of the second display window and the second display signal inputting channel has the second display data input therein; and a multiplexer having a control end, signal input ends and a signal output end turning on the second display signal inputting channel and outputting the second display data or turning on the first display signal inputting channel and outputting the first display data to a display terminal.

### FIELD OF THE INVENTION

The present invention relates to a device and method for synthesizing multi-channel digital display signals into one channel display signal by means of overlapping to display the synthesized display signal on one display terminal.

### BACKGROUND OF THE INVENTION

A display terminal is used to display the detected signal in the form of digital, waveform, diagram or image for the purpose of easy view. One display terminal can only receive one channel display signal at a time, and then the display data of the display signal of said channel are applied to the display electrodes of the display terminal sequentially so that the corresponding pixel, whose coordinates are (X, Y), can present a certain level of gray scale and color.

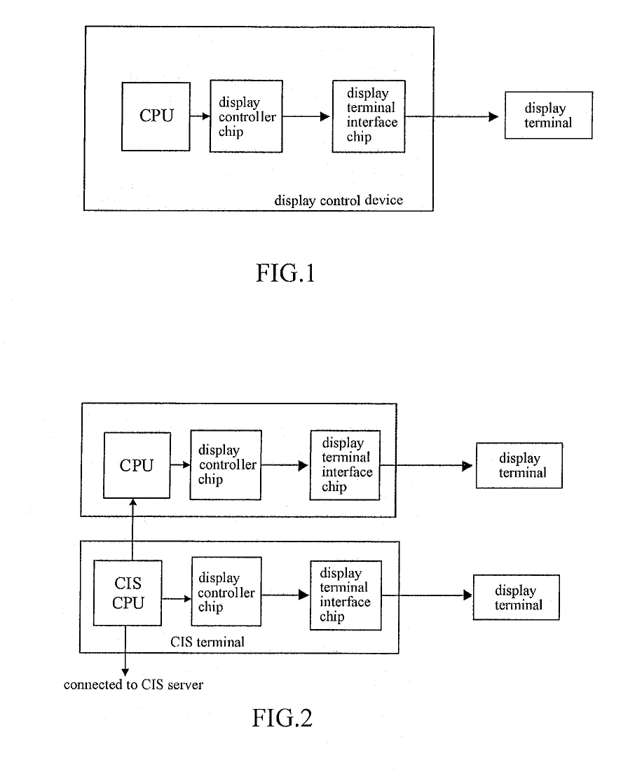

In a medical field, various detected physiological parameters are usually required to be displayed in the form of digital, waveform or diagram etc. through a display terminal, e.g. LCD display screen, of a medical monitor. As the same as most of display control devices, a processor (CPU) of the monitor sends the display information to a display controller chip including video memory. Then the display controller chip outputs a digital display signal in conformity with the VESA Monitor Timing Specification (hereafter, referred as a VESA digital display signal). For the display terminals that can not directly support the VESA digital display signal, an additional interface chip is necessary. The interface chip converts the VESA digital display signal into an analog signal or digital signal which is in conformity with Open LDI, DVI or other standards, as shown in FIG. 1.

On an occasion of application of a monitor, e.g., beside a patient bed or operating-table, a doctor usually needs to recall information of the patient (such as an electronic case history, ultrasonic image, X-ray image etc.) from a server of a Clinic Information System (CIS). A conventional method used therefor is to display CIS information on a display terminal which is different from that of the monitor by a display controller chip of a CIS terminal or device upon acquisition of the CIS information from the server of the CIS, as shown in FIG. 2.

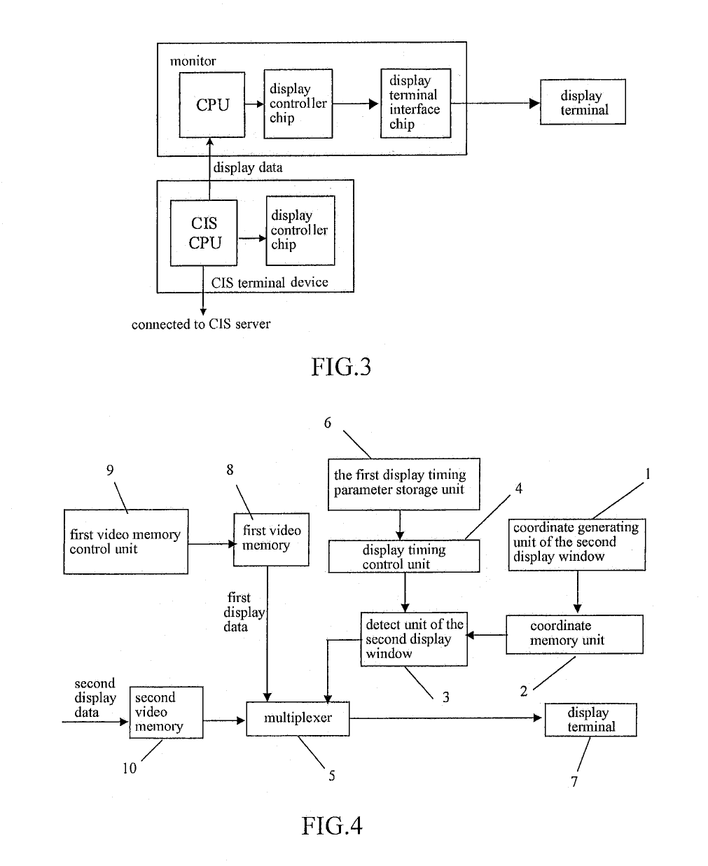

In a limited vacant space beside the patient bed or operating-table, providing an additional CIS display and control terminal in addition to the display terminal of the monitor will inevitably cause a big inconvenience. An optimal solution is to open a window in a display screen of the monitor for displaying data, diagram, etc. transmitted from the CIS processor. Such solution is shown as FIG. 3, wherein desired information is transmitted to the monitor from the CIS terminal, and CIS display information and display information of the monitor itself are transmitted together to a local display controller chip after overlapping via necessary software process by the processor of the monitor, resulting that they are displayed on one display terminal simultaneously. However, such solution is very disadvantageous in that a large quantity of software process resources of the processor of the monitor will be occupied to realize the overlapping of display interfaces. For example, in order to open a window containing 800×600 pixels on the display screen of the monitor for displaying 24-bit color ultrasonograms in which data capacity will be more than 1.4 M bytes, the processor of the monitor should utilize a great many of the software process resources to transmit, process and overlap said 24-bit color ultrasonograms, which will significantly reduce the real-time capability of detecting physiological signals.

### SUMMARY OF THE INVENTION

In order to solve the problem of the prior art, the main object of the present invention is to provide a device and method for overlapping multi-channel digital display signals capable of decreasing the software overhead for overlapping multi-channel (including double channels) display interfaces and reducing the load of processors.

Another object of the present invention is to provide a device and method for overlapping multi-channel digital display signals, realizing the unification of control terminals of a plurality of display devices upon a common use of one display terminal of the multi-channel digital display signals.

In order to carry out the objects above mentioned, the present invention according to preferred embodiments discloses a device for overlapping multi-channel digital display signals, comprising a first display signal inputting channel for inputting first display data to form a first display window on a display terminal; a second display signal inputting channel for inputting second display data to form a second display window on the display terminal; a coordinate generating unit of the second display window for generating coordinates of the second display window to determine a size and location of the second display window overlapped with the first display window; a detection unit of the second display window for receiving coordinates of pixel currently being scanned and the coordinates of the second display window, comparing therebetween, and outputting a valid level of the second display window when the coordinates of the pixel currently being scanned fall within the scope of the coordinates of the second display window and the second display signal inputting channel has the second display data input therein; and a multiplexer having a control end, signal input ends which are used for inputting the first display data and the second display data and a signal output end, the control end of the multiplexer receiving signals output by the detection unit of the second display window, the signal output end of the multiplexer turning on the second display signal inputting channel and outputting the second display data corresponding to the coordinates of the second display window to the display terminal if the detection unit of the second display window outputs the valid level of the second display window, if not, the signal output end of the multiplexer turning on the first display signal inputting channel and outputting the first display data to the display terminal.

Preferably, the device for overlapping multi-channel digital display signals further comprises a coordinate storage unit connected to the coordinate generating unit of the second display window, for storing the coordinates of the second display window, wherein the detection unit of the second display window is connected to the coordinate storage unit to read out the coordinates of the second display window from the coordinate storage unit.

Preferably, the second display signal inputting channel comprises a video memory for storing the second display data, an output end of which is connected with the multiplexer; and a video memory control unit for controlling the video memory to output the second display data.

Preferably, the device for overlapping multi-channel digital display signals further comprises a display timing control unit, a first display timing parameter storage unit and a synchronization control unit, wherein the display timing control unit is connected with the first display timing parameter storage unit to read first display timing parameters and to output a first Horizontal Sync signal, a first Vertical Sync signal and a first display enable signal for the first display data to the display terminal; the display timing control unit is also connected with the detection unit of the second display window to output coordinates of scanned pixels to the detection unit of the second display window upon starting of the scan; the synchronization control unit is coupled to the display timing control unit on its output end for controlling the display timing control unit in response to a second Horizontal Sync signal, a second Vertical Sync signal, a second display enable signal and a second display clock signal for the second display data, wherein the synchronization control unit controls the display timing control unit, when the second display clock signal is not detected, to generate and transmit the first Horizontal Sync signal, the first Vertical Sync signal and the first display enable signal according to the first display timing parameters to the display terminal, when the second display clock signal is detected, to continue scanning, thereafter interrupt at arrival of a Vertical Back Porch of present frame to wait for the arrival of a Back Porch of the second Vertical Sync signal, and when a first rising edge of the second display enable signal is detected by the synchronization control unit, to start scanning again.

Preferably, the display timing control unit is further connected with the detection unit of the second display window to output a first scan status signal to the detection unit of the second display window when generating the first Horizontal Sync signal, the first Vertical Sync signal and the first display enable signal according to the first display timing parameters, for the purpose of controlling the detection unit of the second display window to output an invalid level of the second display window.

Preferably, the second display signal inputting channel comprises a First-in First-Out buffer having an input end for receiving the second display data, an output end connected with the multiplexer and a control end which operates in response to a write enable signal derived from an AND operation between the second display enable signal and a valid synchronization signal outputted by the synchronization control unit and controls the multiplexer to receive the second display data when the write enable signal is valid.

Preferably, the device for overlapping multi-channel digital display signals further comprises a first display clock generating unit for outputting a first display clock signal to the display terminal, wherein the FIFO buffer is connected to the first display clock generating unit and an output end of the first display enable signal of the display timing control unit to output the second display data when the first display enable signal is valid.

Preferably, the device for overlapping multi-channel digital display signals further comprises a master processor for the sake of enabling the display devices which have the display terminal in common use to share a control terminal. The master processor is connected to the coordinate generating unit of the second display window to detect coordinates of the current cursor location and receive the coordinates of the second display window, then decide whether the current cursor location falls within the scope of the second display window, and perform a corresponding process according to the decision. The master processor is also connected to a slave processor. At this point, if the current cursor location falls within the scope of the second display window, the slave processor operates in response to cursor operation transferred from the master processor; and if not, the master processor operates in response to the cursor operation.

In order to carry out the objects above mentioned, the present invention according to preferred embodiments discloses a method for overlapping multi-channel digital display signals, the method comprises the following steps of:

A1. a coordinate generating unit of a second display window generating coordinates of the second display window to determine a size and location of the second display window overlapped with a first display window;

B1. a detection unit of the second display window receiving coordinates of pixel currently being scanned and the coordinates of the second display window, comparing therebetween, and performing step C1 if the coordinates of the pixel currently being scanned fall within the scope of the coordinates of the second display window and second display data is input, otherwise performing step D1;

C1. the detection unit of the second display window outputting a valid level of the second display window, and a signal output end of a multiplexer turning on a second display signal inputting channel and outputting the second display data corresponding to the coordinates of the second display window to a display terminal;

D1. the detection unit of the second display window outputting an invalid level of the second display window, and the signal output end of the multiplexer turning on a first display signal inputting channel and outputting a first display data to the display terminal.

Preferably, the method for overlapping multi-channel digital display signals further comprises a step of synchronization control for synchronizing the scanning for the first display data and the scanning for the second display data, and the step of the synchronization control comprises the step of: the synchronization control unit controlling a display timing control unit, when a second display clock signal is not detected, to generate and transmit the first Horizontal Sync signal, the first Vertical Sync signal and a first display enable signal according to first display timing parameters to the display terminal when the second display clock signal is detected, to continue scanning, thereafter interrupt at arrival of a Vertical Back Porch of present frame to wait for the arrival of a Back Porch of the second Vertical Sync signal, and when a first rising edge of the second display enable signal is detected by the synchronization control unit, to start scanning again.

Preferably, for the sake of enabling the display devices which have the display terminal in common use to share a control terminal, the method further comprises the following steps of:

A2. a master processor detecting coordinates of the current cursor location and receiving coordinates of the second display window;

B2. the master processor comparing the coordinates of the current cursor location with the coordinates of the second display window, and performing step D2 if the current cursor location falls within the scope of the second display window, otherwise performing step C2;

C2. the master processor operating in response to cursor operation;

D2. a slave processor operating in response to the cursor operation transferred from the master processor.

The present invention is advantageous in two aspects as follows.

The present invention realizes a display for overlapping display interfaces of a plurality of display devices on a single display terminal by serving one display device as a master device and other display devices as slave devices, inputting display data from the slave devices into the master device, synchronizing digital display signals outputted from the plurality of display devices by hardware, and overlapping the display data according to a certain specification so as to open a second display window on a first display window. Thus the present invention is capable of decreasing the software overhead for overlapping multi-channel (including double channels) display interfaces and reducing the load of processors.

Present invention realizes the unification of control terminals of a plurality of display devices by detecting the current cursor location and controlling the processor corresponding to a window within which the current cursor locates to operate in response to the cursor operation.

The above and other features and advantages of the present invention will become apparent from the detailed description to preferred embodiments given below with reference to the accompanying drawings.

### DETAILED DESCRIPTION OF THE DRAWINGS

FIG. 1 is a block diagram schematically showing a conventional display device;

FIG. 2 is a block diagram schematically showing two conventional display equipments displaying separately;

FIG. 3 is a block diagram schematically showing a common display terminal shared by two display devices with improvement;

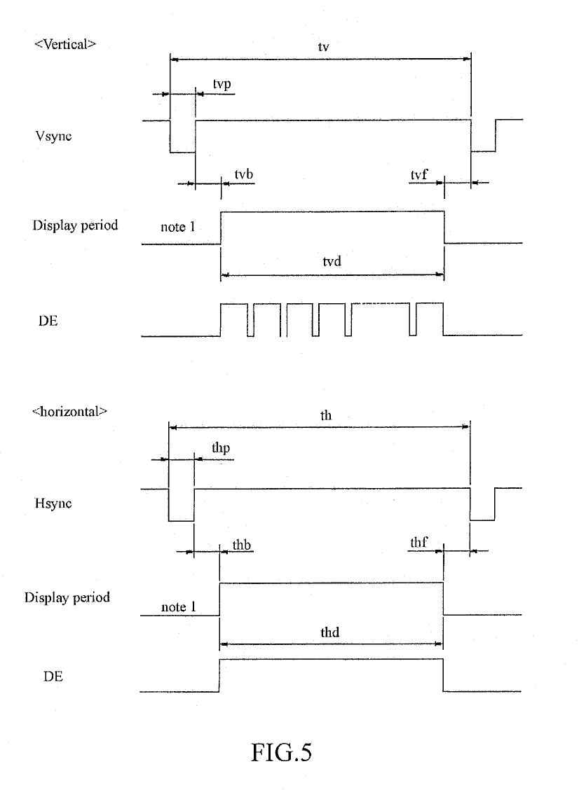

FIG. 4 is a block diagram showing a structure of a device for overlapping multi-channel digital display signals according to an embodiment of the present invention;

FIG. 5 is a timing chart showing Horizontal Sync signals and Vertical Sync signals;

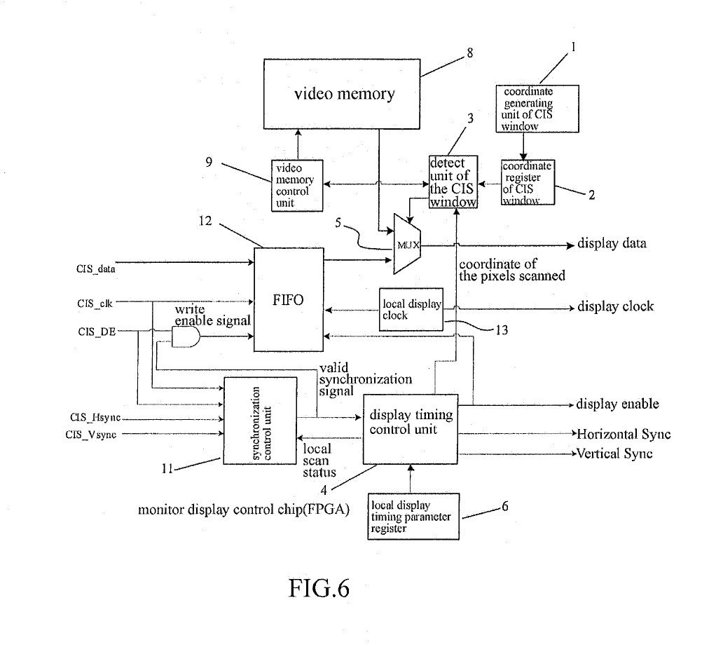

FIG. 6 is a block diagram showing a structure of a device for overlapping multi-channel digital display signals according to another embodiment of the present invention;

FIG. 7 is a schematic diagram showing overlapping of two display windows according to the present invention;

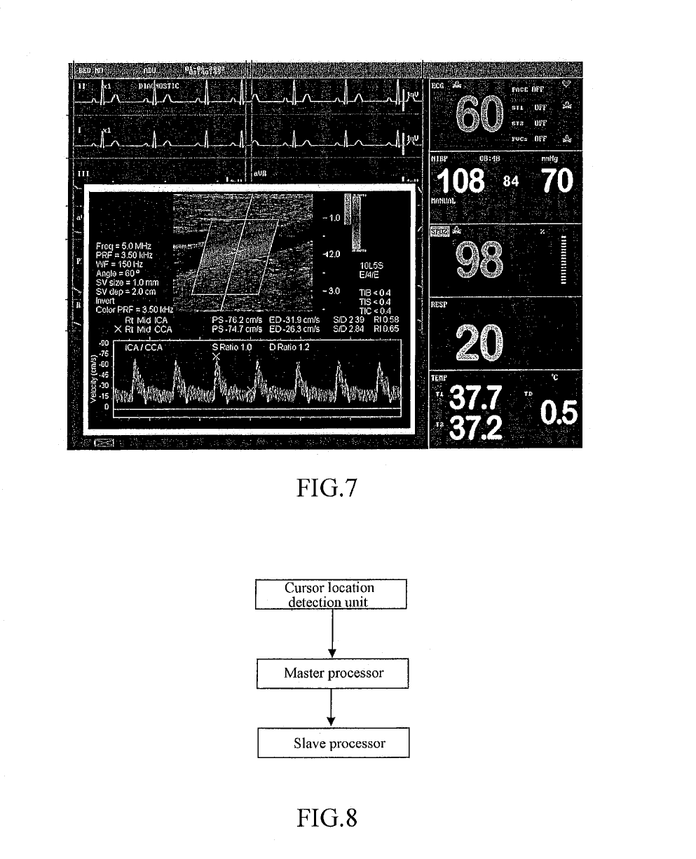

FIG. 8 is a block diagram showing the circuit for realizing the unification of control terminals according to the present invention;

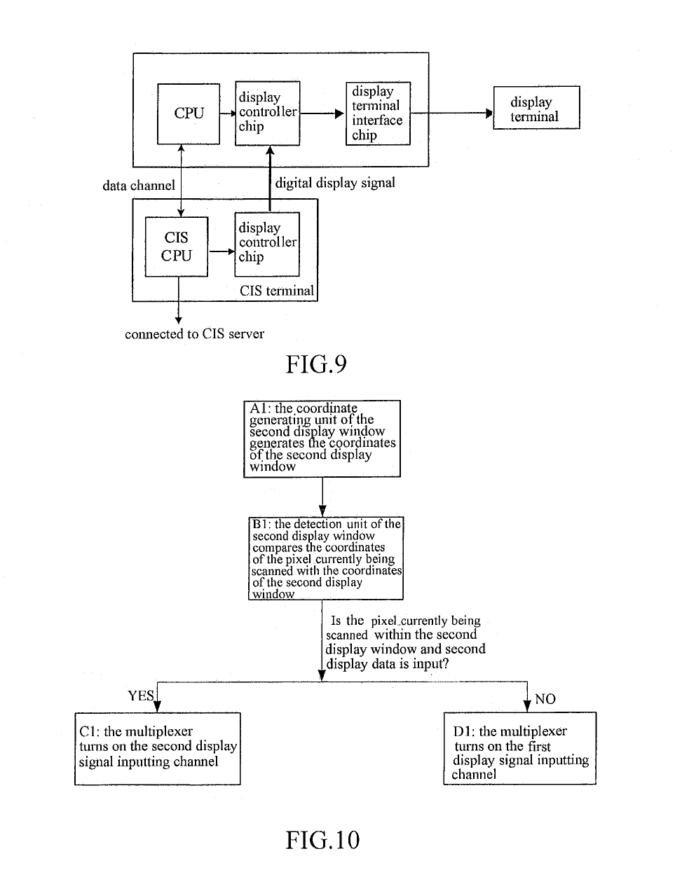

FIG. 9 is a block diagram schematically showing a common display terminal shared by two display devices according to the present invention;

FIG. 10 is a flowchart showing a method for overlapping multi-channel digital display signals according to an embodiment of the present invention; and

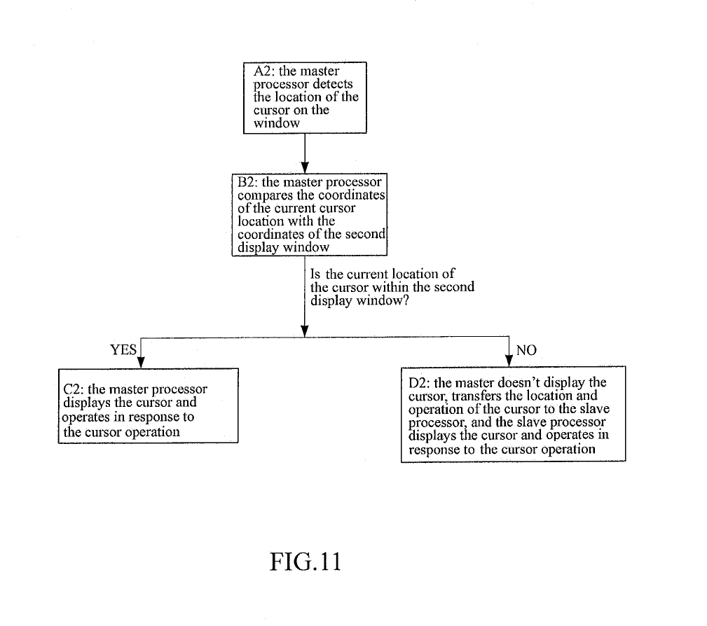

FIG. 11 is a flowchart showing a method for overlapping multi-channel digital display signals according to another embodiment of the present invention.

### DETAILED DESCRIPTION OF THE INVENTION

### First Embodiment

FIG. 4 is a block diagram showing a structure of a device for overlapping multi-channel digital display signals according to the first embodiment. As shown in FIG. 4, a coordinate generating unit of a second display window 1 is connected with a coordinate storage unit 2 to store coordinates of the second display window generated for determining a size and location of the second display window in the coordinate storage unit 2. For example, the coordinate generating unit of the second display window 1 may be a CPU. In this case, the coordinates of the second display window are generated by the software embedded in the CPU, and can be further set by users if necessary. The coordinate generating unit of the second display window 1 may also be realized by hardware. The generating unit of the second display window coordinates 1 may write the generated coordinates into the coordinate storage unit 1 which may be a coordinate register having 16 bits, for example. The coordinate register is defined as Table 1.

TABLE 1

| | | | | | | | | | | | | | | | | |
|---|---|---|---|---|---|---|---|---|---|---|---|---|---|---|---|---|
| Address | 15 | 14 | 13 | 12 | 11 | 10 | 9 | 8 | 7 | 6 | 5 | 4 | 3 | 2 | 1 | 0 |

| | |
|---|---|
| 0 | CIS_wx1: X-coordinate at an upper-left corner of the second |
| | display window |
| 1 | CIS_wy1: Y-coordinate at an upper-left corner of the second |
| | display window |
| 2 | CIS_wx2: X-coordinate at a lower-right corner of the second |
| | display window |
| 3 | CIS_wy2: Y-coordinate at a lower-right corner of the second |
| | display window |

The size and location of the second display window can be determined according to the X-coordinate at the upper-left corner, Y-coordinate at the upper-left corner, X-coordinate at the lower-right corner and Y-coordinate at the lower-right corner of the window.

As shown in FIG. 4, a multiplexer 5 has a control end which is connected to a detection unit 3 of the second display window, signal input ends which are connected to a first video memory 8 and a second video memory 10 and switched between a first display signal inputting channel and a second display signal inputting channel, and a signal output end which is coupled to a display terminal 7 for providing the display terminal 7 with display data. The detection unit of the second display window 3 is also connected to the coordinate storage unit 2 and a display timing control unit 4 which is used to perform Horizontal scan and Vertical scan. The display timing control unit 4 is also connected to the first display timing parameter storage unit 6 to read first display timing parameters and to output a first Horizontal Sync signal, a first Vertical Sync signal and a first display enable signal for first display data to the display terminal 7.

Once pixel scan starts, the display timing control unit outputs coordinates of the scanned pixels to the detection unit of the second display window 3. Then the detection unit of the second display window 3 receives the coordinates of the pixels currently being scanned, reads out the coordinates of the second display window from the coordinate storage unit 2, and compares therebetween. If the coordinates of the pixels currently being scanned fall within the scope of the coordinates of the second display window and second display data is input, a valid level of the second display window is output, and the valid level may be, for example, a high level, so that the multiplexer 5 is controlled to turn on the second display signal inputting channel to output the second display data to the display terminal 7. On the other hand, if the coordinates of the pixel currently being scanned do not fall within the scope of the coordinates of the second display window, and/or the second display data is not input, an invalid level of the second display window will be output, the invalid level may be, for example, a low level, so that the multiplexer 5 is controlled to turn on the first display signal inputting channel to output the first display data to the display terminal 7.

It is assumed that a device for generating the first display data is served as a master device and a device for generating the second display data is served as a slave device. In this case, the first display data is stored in the first video memory 8. A first video memory control unit 9 is connected to the first video memory 8 to control the output of the display data. Further, the first video memory 8 is connected with one of the signal input ends of the multiplexer 5 to constitute the first display signal inputting channel. The device for overlapping multi-channel digital display signals of the present invention may be attached to or built in the master device. The second display data may be stored in a video memory 10 (e.g. the second video memory 10, etc.) which stores a frame of the display data derived from the second display data in real time. The output end of the video memory 10 is connected with another input end of the multiplexer 5, and the second display data is output under the control of a second video memory control unit (not shown in the figure). Thus, the overlapping of images having different resolution rates of two channels or even more channels can be obtained only by adding the second video memory control unit to control the overlapping of the data read directly from the first video memory 8 and the second video memory 10 without synchronization operation.

Many schemes may be employed to achieve the correspondence between the second display data outputted by the second display signal inputting channel and the location of the second display window. One of the schemes is to connect the coordinate generating unit of the second display window 1 with a management unit of the second video memory for the second display data, so that the management unit of the second video memory can control the second video memory to output the second display data falling within the scope of the coordinates of the second display window.

The second scheme is to add a detection unit of the second display data which is connected between the video memory 10 and the multiplexer 5 for receiving the coordinates of the second display window coordinates and the second display data and only outputting the second display data falling within the scope of the coordinates of the second display window to the multiplexer 5.

FIG. 10 is a flowchart showing a method for overlapping multi-channel digital display signals according to an embodiment of the present invention. At step A1, the coordinate generating unit of the second display window generates the coordinates of the second display window to determine the size and location of the second display window overlapped with the first display window. Then at step B1, the detection unit of the second display window receives the coordinates of the pixel currently being scanned and the coordinates of the second display window, compares therebetween, thereafter determines whether the coordinates of the pixel currently being scanned fall within the scope of the coordinates of the second display window and determines whether the second display data is input, if both yes, the process proceeds to step C1 where the detection unit of the second display window outputs a valid level of the second display window, and the signal output end of the multiplexer turns on the second display signal inputting channel and outputs the second display data corresponding to the coordinates of the second display window to the display terminal. On the other hand, if either of the two determination results is negative, the process proceeds to step D1 where the detection unit of the second display window outputs an invalid level of the second display window, and the signal output end of the multiplexer turns on the first display signal inputting channel and outputs the first display data to the display terminal.

### Second Embodiment

The following is a detailed illustration about the embodiment of applications of the present invention. As an example, a medical monitor is used as a master device, a Clinic Information System (CIS) is used as a slave device, and the device for overlapping multi-channel digital display signals of the present invention is provided on the monitor. Specially, as shown in FIG. 6, a coordinate generating unit of a CIS window 1 is used as the coordinate generating unit of the second display window, a coordinate register of the CIS window 2 is used as the coordinate storage unit, and a detection unit of the CIS window 3 is used as the detection unit of the second display window. In the following text, digital display signal outputted by a CIS terminal is referred as a CIS signal and digital display signal of the monitor itself is referred as a local signal, so as to simplify the illustration. In a case that a small capacity buffer is used to buffer the CIS signal, a key point about the synthesis of the digital display signals from two channels is to solve issues derived from signal synchronization and data overlapping. For the display signals with a same resolution rate, the display clock frequency, Horizontal display period thd and Vertical display period tvd are same, but there may be difference in respective Horizontal Front Porch, Horizontal Back Porch, Vertical Back Porch, Vertical Back Porch between the first display signal inputting channel and the second display signal inputting channel. Since the monitor itself cannot control the timing parameters of the CIS signal, it is necessary for the local signal to follow the timing parameters of the CIS signal in order to achieve synchronization.

The timing relationship of digital display signals will be explained hereinafter. Generally, the display device displays images in a form of dot matrix consisting of pixels arranged in rows and columns, wherein the color and gray scale of a pixel is represented by several bits of data. For example, a typical 17′ display has 1280×1024 pixels, and each of the pixels is represented by 24-bit data. Generally, by scanning line by line, a display control device reads out the dot matrix information stored in a video memory frame by frame and line by line according to a clock frequency, and transmits it together with several control signals to the display device. VESA Monitor Timing Specification is a specification for defining such digital display signals. These digital display signals includes a display clock signal, display data signal, Horizontal Sync signal (Hysnc), Vertical Sync signal (Vsync) and display enable signal DE, and the timing relationship among them is as shown in FIG. 5. When the display enable signal DE is high level, the display controller chip sequentially outputs the display data of each pixel in a line according to the display clock frequency (the clock and display data are not shown in FIG. 5). A display period for a line is referred as thd. The DE signal will become invalid once the scan for a line has been completed. And if a Front Porch of a Horizontal thf elapses, the Horizontal Sync signal will become valid, with a pulse width of thp. Then if a Back Porch of a Horizontal thb elapses, DE becomes valid again and the scan for the next line starts. Further, a display period for a frame is referred as tvd. Once the scan for a frame has been completed, the Vertical Sync signal will become valid with a pulse width of tvp. Then if a Back Porch of a Vertical tvb elapses, the scan for the next frame starts. As per cycles above-mentioned, the display data will be transmitted to the display device continuously.

The difference between the present embodiment and the First Embodiment lies in that the present embodiment has a synchronization control unit 11 added, as shown in FIG. 6. The synchronization control unit 11 operates in response to the second Horizontal Sync signal CIS_Hsync, the second Vertical Sync signal CIS_Vsync, the second display enable signal CIS_DE and the second display clock signal CIS_clk, and its output end is coupled to the display timing control unit 4. In practice, the synchronization control unit 11 may be a status machine which switches among a plurality of statuses according to the CIS signal and local scan status, wherein the plurality of statuses comprise:

1) Non-CIS Status

If the second display clock signal CIS_clk is not detected, it indicates that there is no CIS signal currently. Then the synchronization control unit 11 outputs the corresponding signal to the display timing control unit 4, the latter generates the first Horizontal Sync signal, the first Vertical Sync signal, and the first display enable signal etc according to the first display timing parameters (i.e., the set values of the local timing parameter register 6), and outputs these signals to the display terminal. Also, the first video memory control unit 9 sequentially outputs the display data of each pixel according to the local scan status signal (i.e., the first scan status signal) outputted by the display timing control unit 4. The display timing control unit 4 also outputs the local scan status signal to the detection unit of the second display window 3 to control the detection unit of the second display window 3 to output an invalid level of the second display window, so as to enable the input end of the multiplexer 5 switching to the local display data without the input of CIS data.

2) Pending Synchronization Status

Once the second display clock signal CIS_clk is detected which means that there is a valid CIS signal, the synchronization control unit 11 notifies the display timing control unit that the synchronization control unit 11 enters into a pending synchronization status. In order to prevent the screen from flickering, the display timing control unit will not change the timing parameters at once, but continue scanning, thereafter interrupt at arrival of a Back Porch of present frame Vertical to wait for the arrival of a Back Porch of the second Vertical Sync signal CIS_Vsync. If the Vertical Back Porch of the present frame never comes, i.e., there is no Vertical Sync pulse, the status machine will switch to non-CIS status after a certain time elapses.

3) Quasi-Synchronization Status

When the rising edge of the second Vertical Sync signal CIS_Vsync is detected which indicates that the CIS also enters the Vertical Back Porch of present frame, the synchronization control unit 11 comes into the quasi-synchronization status.

4) Synchronization Status

The synchronization control unit 11 detects the second display enable signal CIS CIS_DE in the quasi-synchronization status. Once a first DE rising edge is detected, the display timing control unit is advised to begin scan immediately. Then the synchronization control unit 11 turns into the synchronization status. Subsequently, the synchronization control unit 11 detects the DE of the next line/frame at the Horizontal Back of each line and the Vertical Back of each frame of the CIS. Once the DE rising edge of the CIS is detected, the scan for the next line/frame will starts immediately. At this point, the synchronization control unit 11 immediately outputs a valid synchronization signal to the display timing control unit 4, and the display timing control unit 4 in turn outputs the Horizontal Sync signal, the Vertical Sync signal. Therefore, the Horizontal Sync signal, the Vertical Sync signal, the Horizontal Display period and the Vertical Display period of the local display signal are consistent with that of the CIS respectively.

Since in the synchronization status, the display enable signal DE and Horizontal/Vertical Sync signal for the local signal are generated after the display enable signal DE and Horizontal/Vertical Sync signal of the CIS are detected, the local signal is delayed 1 or 2 clock period(s) with respect to the CIS signal. In this case, the display data should be delayed as well. For this reason, a First-in First-Out (FIFO) buffer 12 with small capacity is added in the second display signal inputting channel to buffer the CIS display data. The FIFO buffer 12 receives the second display data CIS_data as data input at its input end, and its output end is connected with the multiplexer 5. A control end of the FIFO buffer 12 operates in response to a write enable signal obtained by an AND operation between the second display enable signal DIS_DE and the valid synchronization signal outputted by the synchronization control unit 11, and controls the multiplexer to receive the second display data when the write enable signal is valid. A first display clock generating unit 13 outputs a first display clock signal to the display terminal and to the FIFO buffer 12. The FIFO buffer 12 is also connected to the output end of the first display enable signal of the display timing control unit 4 to output the second display data when the first display enable signal is valid.

When it is necessary to open a window on the display screen of the monitor to display CIS information, the coordinate generation unit of the second display window 1 will write the coordinates at the upper-left corner and lower-right corner of the window into the coordinate register of the CIS window. Meanwhile, the coordinate generation unit of the second display window 1 informs the CIS processor to display relevant information in corresponding areas. The coordinate generation unit of the second display window 1 can set the coordinates of the second display window according to the size and location of the window required by the users.

On the display screen, each pixel corresponds to a set of coordinates (x, y) representing the pixel of xth row and yth column. The display timing control unit will output the current scan status, i.e., the coordinates of the pixel currently being scanned. The detection unit of the CIS window compares the X-coordinate x of the pixel currently being scanned with CIS_wx1 and CIS_wx2. When it satisfies that CIS_wx1□x□CIS_wx2, the signal CIS_wx is set as 1. Similarly, when the Y-coordinate y satisfies that CIS_wy1□y□CIS_wy2, the signal CIS_wy is set as 1. The signal CIS_window is the result of logic “AND” operation of CIS_wx and CIS_wy. If CIS_window is 1, it indicates that the pixel currently being scanned falls within the CIS window, otherwise it is outside. The multiplexer is controlled by the CIS_window signal. One of the inputs of the multiplexer is FIFO data, i.e., CIS display data, another input is local display data. When CIS_window is 1, the multiplexer 5 switches to the CIS display data, otherwise switches to the local display data. Thus, an image corresponding to CIS areas is displayed within the window, resulting=the effect of Picture in Picture, as shown in FIG. 7. If it is desired to display a local interface inside the window and display a CIS interface outside, only the conditions for switching of the multiplexer needs to be changed.

The coordinate generation unit of the second display window, the coordinate storage unit, the detection unit of the second display window, the multiplexer, the buffer and the synchronization control unit can be integrated in the display controller chip of the monitor, and the FPGA/ASIC can be used to implement the display control circuit.

According to the present embodiment, the present invention may also be applied for the other display devices that require displaying two or more channels of display signals.

### Third Embodiment

In present embodiment, the display screen of the master device will be served as not only a display terminal but also a control terminal to control the operation relating to the selection of menu, the typing of characters etc. through the input devices such as a mouse, keyboard etc on the display screen. Since the interfaces inside and outside of the window are controlled by different processors respectively, the slave device cannot operate directly in response to the control of the local mouse and keyboard. Therefore, on the basis of the First Embodiment or the Second Embodiment, the device for overlapping multi-channel digital display signals according to the present embodiment further comprises a master processor for detecting the cursor location and operating in response to the cursor operation. As shown in FIG. 8, the master processor (i.e., the processor of the master device) is connected to the cursor location detection unit. There will be only one cursor in the scope of inside and outside of the window at one time. And the master processor detects the coordinates of the current cursor location and receives the coordinates of the second display window, decides whether the current cursor location falls within the scope of the second display window, and performs a corresponding process according to the decision. The master processor may also be connected to the slave processor (i.e., the processor of the slave device). In this case, when the current cursor location does not fall within the scope of the second display window, the master processor operates in response to the cursor operation. Specially, when the cursor on the screen moves from the outside of the window to the inside, passes through the boundary of the window, and locates in the scope of the second display window under the control of the local mouse or keyboard, the master processor transfers the cursor operation to the slave processor instead of displaying the cursor, and advises the slave processor to display the cursor at the internal boundary of the window and to operate in response to the cursor operation. In such manner, the smooth transition for cursor between inside and outside of the window is completed. As well, the master processor transfers the subsequent coordinates to the slave processor in real time so that the display and movement of the cursor within the window may be implemented by the slave device. Any operation of the mouse and the keyboard in the cursor focus may also be transferred from the master device (for example the monitor) to the slave device (for example, the CIS terminal) which in turn executes relevant operation and display. When the cursor moves to the outside of the window, the master processor takes charge of the display of the cursor again and operates in response to the input device.

The connection between the master processor and slave processor can be realized by one data channel which may be a serial port, USB or other communication means, as shown in FIG. 9.

FIG. 11 is a flowchart showing a method for overlapping multi-channel digital display signals according to another embodiment of the present invention. At step A2, the master processor detects the coordinates of the current cursor location, and receives the coordinates of the second display window. Next at step B2, the master processor compares the coordinates of the current cursor location with the coordinates of the second display window, and decides whether the current cursor location falls within the scope of the second display window. If the decision is positive, then the process proceeds to step D2 where the master processor transfers the cursor location and the cursor operation to the slave processor and the slave processor displays the cursor and operates in response to the cursor operation. On the other hand, if the decision is negative, then the process proceeds to step C2 where the master processor displays the cursor and operates in response to the cursor operation.

The present invention according to each embodiment above mentioned may carry out the advantageous effects in two aspects as follows.

The present invention according to embodiments realizes a display for overlapping display interfaces of a plurality of display devices on a single display terminal by serving one display device as a master device and other display devices as slave devices, inputting display data from the slave devices into the master device, synchronizing digital display signals outputted from the plurality of display devices by hardware, and overlapping the display data according to a certain specification so as to open a second display window on a first display window. Thus the present invention is capable of decreasing the software overhead for overlapping multi-channel (including double channels) display interfaces and reducing the load of processors.

The present invention according to embodiments realizes the unification of control terminals of a plurality of display devices by detecting the current cursor location and controlling the processor corresponding to a window within which the current cursor locates to operate in response to the cursor operation.

What is claimed is:

1. A device for overlapping multi-channel digital display signals, the device comprises:
a first display signal inputting channel for inputting first display data to form a first display window on a display terminal;
a second display signal inputting channel for inputting second display data to form a second display window on the display terminal;
a coordinate generating unit of the second display window for generating coordinates of the second display window to determine a size and location of the second display window overlapped with the first display window;
a detection unit of the second display window for receiving coordinates of pixel currently being scanned and the coordinates of the second display window, comparing therebetween, and outputting a valid level of the second display window when the coordinates of the pixel currently being scanned fall within the scope of the coordinates of the second display window and the second display signal inputting channel has the second display data input therein; and
a multiplexer having a control end, signal input ends which are used for inputting the first display data and the second display data and a signal output end, the control end of the multiplexer receiving signals output by the detection unit of the second display window, the signal output end of the multiplexer turning on the second display signal inputting channel and outputting the second display data corresponding to the coordinates of the second display window to the display terminal if the detection unit of the second display window outputs the valid level of the second display window, if not, the signal output end of the multiplexer turning on the first display signal inputting channel and outputting the first display data to the display terminal.

2. The device for overlapping multi-channel digital display signals according to claim 1, wherein the device further comprises a coordinate storage unit connected to the coordinate generating unit of the second display window for storing the coordinates of the second display window, wherein the detection unit of the second display window is connected to the coordinate storage unit to read out the coordinates of the second display window from the coordinate storage unit.

3. The device for overlapping multi-channel digital display signals according to claim 1, wherein the second display signal input channel comprises a video memory for storing the second display data, an output end of which is connected with the multiplexer; and a video memory control unit for controlling the video memory to output the second display data.

4. The device for overlapping multi-channel digital display signals according to claim 2, wherein the second display signal input channel comprises a video memory for storing the second display data, an output end of which is connected with the multiplexer; and a video memory control unit for controlling the video memory to output the second display data.

5. The device for overlapping multi-channel digital display signals according to claim 1, wherein the device further comprises a display timing control unit, a first display timing parameter storage unit and a synchronization control unit, wherein the display timing control unit is connected with the first display timing parameter storage unit to read first display timing parameters and to output a first Horizontal Sync signal, a first Vertical Sync signal and a first display enable signal for the first display data to the display terminal; the display timing control unit is also connected with the detection unit of the second display window to output coordinates of scanned pixels to the detection unit of the second display window upon starting of the scan; the synchronization control unit is coupled to the display timing control unit on its output end for controlling the display timing control unit in response to a second Horizontal Sync signal, a second Vertical Sync signal, a second display enable signal and a second display clock signal for the second display data, wherein the synchronization control unit controls the display timing control unit, when the second display clock signal is not detected, to generate and transmit the first Horizontal Sync signal, the first Vertical Sync signal and the first display enable signal according to the first display timing parameters to the display terminal, when the second display clock signal is detected, to continue scanning, thereafter interrupt at arrival of a Vertical Back Porch of present frame to wait for the arrival of a Back Porch of the second Vertical Sync signal, and when a first rising edge of the second display enable signal is detected by the synchronization control unit, to start scanning again.

6. The device for overlapping multi-channel digital display signals according to claim 2, wherein the device further comprises a display timing control unit, a first display timing parameter storage unit and a synchronization control unit, wherein the display timing control unit is connected with the first display timing parameter storage unit to read first display timing parameters and to output a first Horizontal Sync signal, a first Vertical Sync signal and a first display enable signal for the first display data to the display terminal; the display timing control unit is also connected with the detection unit of the second display window to output coordinates of scanned pixels to the detection unit of the second display window upon starting of the scan; the synchronization control unit is coupled to the display timing control unit on its output end for controlling the display timing control unit in response to a second Horizontal Sync signal, a second Vertical Sync signal, a second display enable signal and a second display clock signal for the second display data, wherein the synchronization control unit controls the display timing control unit, when the second display clock signal is not detected, to generate and transmit the first Horizontal Sync signal, the first Vertical Sync signal and the first display enable signal according to the first display timing parameters to the display terminal, when the second display clock signal is detected, to continue scanning, thereafter interrupt at arrival of a Vertical Back Porch of present frame to wait for the arrival of a Back Porch of the second Vertical Sync signal, and when a first rising edge of the second display enable signal is detected by the synchronization control unit, to start scanning again.

7. The device for overlapping multi-channel digital display signals according to claim 5, wherein the display timing control unit is further connected with the detection unit of the second display window to output a first scan status signal to the detection unit of the second display window when generating the first Horizontal Sync signal, the first Vertical Sync signal and the first display enable signal according to the first display timing parameters, for the purpose of controlling the detection unit of the second display window to output an invalid level of the second display window.

8. The device for overlapping multi-channel digital display signals according to claim 5, wherein the second display signal input channel comprises a First-in First-Out buffer having an input end for receiving the second display data, an output end connected with the multiplexer and a control end which operates in response to a write enable signal derived from an AND operation between the second display enable signal and a valid synchronization signal outputted by the synchronization control unit and controls the multiplexer to receive the second display data when the write enable signal is valid.

9. The device for overlapping multi-channel digital display signals according to claim 8, wherein the device further comprises a first display clock generating unit for outputting a first display clock signal to the display terminal, wherein the FIFO buffer is connected to the first display clock generating unit and an output end of the first display enable signal of the display timing control unit to output the second display data when the first display enable signal is valid.

10. The device for overlapping multi-channel digital display signals according to claim 1, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

11. The device for overlapping multi-channel digital display signals according to claim 2, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

12. The device for overlapping multi-channel digital display signals according to claim 3, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

13. The device for overlapping multi-channel digital display signals according to claim 4, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

14. The device for overlapping multi-channel digital display signals according to claim 5, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

15. The device for overlapping multi-channel digital display signals according to claim 7, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

16. The device for overlapping multi-channel digital display signals according to claim 8, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

17. The device for overlapping multi-channel digital display signals according to claim 9, wherein the device further comprises a master processor, wherein the master processor is connected to the coordinate generating unit of the second display window to detect coordinates of the current cursor location and receive the coordinates of the second display window, then decide whether the current cursor location falls within the scope of the second display window, and perform a corresponding process according to the decision, and the master processor is also connected to a slave processor, in this case, if the current cursor location falls within the scope of the second display window, the slave processor operates in response to cursor operation transferred from the master processor; and if not, the master processor operates in response to the cursor operation.

18. A method for overlapping multi-channel digital display signals, wherein the method comprises the following steps of:
A1. a coordinate generating unit of a second display window generating coordinates of the second display window to determine a size and location of the second display window overlapped with a first display window;
B1. a detection unit of the second display window receiving coordinates of pixel currently being scanned and the coordinates of the second display window, comparing therebetween, and performing step C1 if the coordinates of the pixel currently being scanned fall within the scope of the coordinates of the second display window and second display data is input, otherwise performing step D1;
C1. the detection unit of the second display window outputting a valid level of the second display window, and a signal output end of a multiplexer turning on a second display signal inputting channel and outputting the second display data corresponding to the coordinates of the second display window to a display terminal;
D1. the detection unit of the second display window outputting an invalid level of the second display window, and the signal output end of the multiplexer turning on a first display signal inputting channel and outputting a first display data to the display terminal.

19. The method for overlapping multi-channel digital display signals according to the claim 18, wherein the method further comprises a step of synchronization control for synchronizing the scanning for the first display data and the scanning for the second display data, and the step of the synchronization control comprises the step of: the synchronization control unit controlling a display timing control unit, when a second display clock signal is not detected, to generate and transmit the first Horizontal Sync signal, the first Vertical Sync signal and a first display enable signal according to first display timing parameters to the display terminal when the second display clock signal is detected, to continue scanning, thereafter interrupt at arrival of a Vertical Back Porch of present frame to wait for the arrival of a Back Porch of the second Vertical Sync signal, and when a first rising edge of the second display enable signal is detected by the synchronization control unit, to start scanning again.

20. The method for overlapping multi-channel digital display signals according to the claim 19, wherein the method further comprises the following steps of:
A2. a master processor detecting coordinates of the current cursor location and receiving coordinates of the second display window;
B2. the master processor comparing the coordinates of the current cursor location with the coordinates of the second display window, and performing step D2 if the current cursor location falls within the scope of the second display window, otherwise performing step C2;
C2. the master processor operating in response to cursor operation;
D2. a slave processor operating in response to the cursor operation transferred from the master processor.
